(19) United States
(12) Patent Application Publication
(10) Pub. No.: US 2009/0252896 A1
(43) Pub. Date: Oct. 8, 2009

(54) HYBRID FILM, METHOD FOR THE PRODUCTION THEREOF AND OPTICALLY COMPENSATORY FILM, POLARIZING PLATE AND LIQUID CRYSTAL DISPLAY DEVICE USING THE SAME

(75) Inventors: Hajime Nakayama, Kanagawa (JP); Takashi Kobayashi, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/063,898

(22) PCT Filed: Aug. 22, 2006
(86) PCT No.: PCT/JP2006/316798

§ 371 Date: Feb. 15, 2008

(30) Foreign Application Priority Data
Aug. 22, 2005 (JP) 2005-240293

(51) Int. Cl. C09K 19/02; B32B 27/42; B32B 27/36; B32B 27/28; B32B 27/06; B32B 23/08; C08G 63/48; C09D 101/10

(52) U.S. Cl. 428/1.1; 428/220; 428/480; 428/475.2; 428/473.5; 428/526; 525/54.21; 106/168.01

(57) ABSTRACT

A dope solution in which a cellulose acylate and a cycloolefin compound having a mass-average molecular mass of from 200 to 20,000 are dissolved in admixture is subjected to solution film forming to obtain a hybrid film. Further, an optically anisotropic layer having retardation Re of from 0 nm to 200 nm is provided on the hybrid film to prepare an optically compensatory film. The optically compensatory film and a polarizer are stuck to each other to prepare a polarizing plate which is then used to obtain a liquid crystal display device.

### TECHNICAL FIELD

The present invention relates to a hybrid film, a method for the production of same, and an optically compensatory film, a polarizing plate and a liquid crystal display device comprising same.

### BACKGROUND ART

In recent years, the market of thin display devices has been growing. Among these thin display devices, liquid crystal display devices have shown a remarkable market growth. These liquid crystal display devices are now under development not only for monitor for personal computer but also for TV. With this trend, the screen size has increased and the screen fineness has raised more and more. Under these circumstances, it has been more and more desired to improve the performance of various parts contained in liquid crystal display devices.

A liquid crystal display device normally comprises a liquid crystal cell and a polarizing plate. In general, when light is incident on the incidence side polarizing plate, it then becomes linearly polarized light that enters the liquid crystal cell. The liquid crystal cell then makes ON/OFF switching of polarized light depending on the alignment of the liquid crystal molecules. The light comes out of the viewing side polarizing plate to make image display. Thus, the polarizing plate is a member essential for liquid crystal display devices. The polarizing plate has a protective film and a polarizer. The polarizing plate is obtained, e.g., by dyeing a polarizer made of a polyvinyl alcohol (PVA) film with iodine, stretching the polarizer, and then laminating the polarizer with a protective film on both surfaces thereof.

As the protective film for polarizing plate there has been normally used a cellulose acylate film. A cellulose acylate film exhibits an excellent adhesion to a polyvinyl alcohol (PVA) which is used as an ordinary polarizer, a good transparency and hence little or no optical anisotropy, excellent physical and mechanical properties and a relatively small dimensional change with temperature and humidity.

In recent years, however, the screen fineness of the liquid crystal display devices has increased more and more. With this trend, the cellulose acylate film to be used as protective film for polarizing plate has been desired to have further improvements in properties and durability, e.g., better light transmission properties, small temperature and humidity dependence of optical anisotropy (retardation), moisture permeability suitable for sticking to PVA, good adhesion to polarizer, excellent planarity, elastic modulus suitable for handling as film, little dimensional change. There have recently arisen problems of so-called “frame defective” and “corner unevenness”, which involve the leakage of light from the four side edges of the screen and from the four corners, respectively, during black display when the durability of the members incorporated in the liquid crystal display device is insufficient.

In an attempt to enhance the durability of cellulose acylate film, it has been proposed to use a cellulose acylate solution flow casting film forming method. In some detail, a dope composition having components properly selected from the group consisting of low molecular plasticizers (e.g., phosphoric acid esters, phthalic acid esters) and polymeric plasticizers (e.g., polyester ether, polyester-urethane, polyester) incorporated therein singly or in admixture is used (e.g., JP-B-47-760, JP-B-43-16305, JP-B-44-32672, JP-A-2-292342, JP-A-5-197073). There is also a technique of mixing a polymethyl acrylate or copolymer of methyl acrylate with a cellulose acetate to provide the plasticity of cellulose acylate film (see, e.g., U.S. Pat. No. 3,277,032). However, these supports, too, leave something to be desired in weathering resistance such as film strength stability after prolonged storage and resistance to film coloration.

In order to enhance the compatibility with cellulose acylate, it has been proposed to blend with a polyester polymer having much content of low molecular materials (see, e.g., JP-A-2002-22956). However, since the polymer is a low molecular compound or has an insufficient hydrophobicity itself, there arises a problem that characteristics of polymer cannot be sufficiently developed.

As mentioned above, since the properties of cellulose acylate film cannot be difficulty improved, it has been proposed to use other material as protective film for polarizing plate. It has been proposed that a polycarbonate-based film or thermoplastic cycloolefin film be used instead of cellulose acylate film to form a protective film for polarizing plate (Examples of commercially available products include ZEONOR (produced by Zeon Corporation) and ARTON (produced by JSR Corporation). These films exhibit a smaller change of physical properties with temperature or humidity and a better durability than cellulose acylate film. However, these optical transparent films are disadvantageous in that when used as a protective film for polarizing plate, they can be difficultly stuck to a hydrophilic PVA polarizer because they are hydrophobic or they show a poor adaptability to handling because they show a small elastic modulus. Further, since these films are normally produced by melt film forming, they leave something to be desired in uniformity in surface conditions.

### DISCLOSURE OF THE INVENTION

A first aim of the invention is to provide a hybrid film having the aforementioned characteristics of cellulose acylate film and cycloolefin-based film in combination and a method for the production thereof. More particularly, the first aim of the invention is to provide a hybrid film having an excellent transparency like cellulose acylate film, an excellent planarity developed by solution filming, a proper moisture permeability, a good adhesion to PVA which is a polarizer, an elastic modulus suitable for handling as film and showing little dimensional change and a small temperature and humidity dependence of optical anisotropy (retardation) and hence an excellent durability like cycloolefin-based film and a method for the production thereof.

A second aim of the invention is to provide a support for optically compensatory film and a protective film for polarizing plate comprising the aforementioned hybrid film and a liquid crystal display device, particularly of VA mode or IPS mode having recently showed a trend for more use in TV in a remarkable trend for larger size, which comprises the aforementioned support and protective film incorporated therein to cause little frame defectives and corner unevenness.

The inventors solved the aforementioned problems by hybridizing cellulose acylate with cycloolefin compound. In general, polymers can be difficultly mixed with each other. Therefore, it was difficult at the beginning to mix cellulose acylate with cycloolefin polymer so that they are hybridized with each other. As a result of extensive studies, however, it was found that when a cycloolefin compound having a mass-average molecular mass falling within a predetermined range is mixed with a cellulose acylate, they can be fairly compatibilized with each other, making it possible to obtain a hybrid film having physical properties suitable for optical film. It was also found that a desired hybrid film can be produced by using, as a method for obtaining a cycloolefin compound having a mass-average molecular mass falling within a specific range, (i) method involving the use of a cycloolefin compound prepared by reducing the molecular mass of a thermoplastic norbornene-based resin, (ii) method involving the use of a cycloolefin compound obtained by properly polymerizing monomers, (iii) method involving the use of a cycloolefin compound having a molecular mass of from 200 to 3,000, or the like.

The invention has been worked out by the following constitutions (1) to (19).

(1) A hybrid film comprising:

a cellulose acylate; and

a cycloolefin compound having a mass-average molecular mass of from 200 to 20,000.

(2) The hybrid film as described in (1) above,

wherein the cellulose acylate has an acyl substitution degree of from 2.0 to 3.0.

(3) The hybrid film as described in (2) above,

wherein the cellulose acylate has an acyl-substituted group that comprises substantially only an acetyl group, and has an acyl substitution degree of from 2.5 to 3.0.

(4) The hybrid film as described in (2) above,

wherein the cellulose acylate has an acyl-substituted group that comprises substantially at least two groups selected from the group consisting of acetyl group, propionyl group and butanoyl group.

(5) The hybrid film as described in (2) above,

wherein the cellulose acylate has an acyl-substituted group that comprises substantially acetyl group and propionyl group.

(6) The hybrid film as described in any of (1) to (5) above, which has a haze of from 0.01% to 5.0%.

(7) The hybrid film as described in any of (1) to (6) above, which has a thickness of from 20 μm to 200 μm.

(8) The hybrid film as described in any of (1) to (7) above, which satisfies relationship (1):

A/B≦0.98 (1)

wherein A represents a moisture permeability of the hybrid film; and

B represents a moisture permeability of a film prepared from only the cellulose acylate contained in the hybrid film.

(9) The hybrid film as described in any of (1) to (8) above, which satisfies relationship (2):

0.5≦C/D≦1.5 (2)

wherein C represents an elastic modulus of the hybrid film; and

D represents an elastic modulus of a film prepared from only the cellulose acylate contained in the hybrid film.

(10) The hybrid film as described in any of (1) to (9) above, which satisfies relationship (3):

0.5≦E/F≦1.5 (3)

wherein E represents a tensile elongation at break of the hybrid film; and

F represents an tensile elongation at break of a film prepared from only the cellulose acylate contained in the hybrid film.

(11) The hybrid film as described in any of (1) to (10) above, which satisfies relationship (4):

G/H≦0.98 (4)

wherein G represents a photoelastic coefficient of the hybrid film; and

H represents a photoelastic coefficient of a film prepared from only the cellulose acylate contained in the hybrid film.

(12) The hybrid film as described in any of (1) to (11) above, which satisfies relationship (5):

I/J≦0.98 (5)

wherein I represents a percent dimensional change (%) of the hybrid film; and

J represents a percent dimensional change (%) of a film prepared from only the cellulose acylate contained in the hybrid film.

(13) A method for a production of a hybrid film as described in any of (1) to (12) above, which comprises:

preparing a dope solution in which a cellulose acylate and a cycloolefin compound having a mass-average molecular mass of from 200 to 20,000 are dissolved in admixture; and

forming a film from the dope solution.

(14) The method as described in (13) above,

wherein the cycloolefin compound is prepared by lowering a molecular mass of a thermoplastic norbornene-based resin.

(15) The method as described in (13) above,

wherein the cycloolefin compound is prepared by polymerizing a cycloolefin monomer.

(16) The method as described in (13) above,

wherein the cycloolefin compound is a monomer having a molecular mass of from 200 to 3,000.

(17) An optically compensatory film comprising:

a hybrid film as described in any of (1) to (12) above; and

an optically anisotropic layer having a retardation Re of from 0 nm to 200 nm.

(18) A polarizing plate comprising:

at least one of a hybrid film as described in any of (1) to (12) above and an optically compensatory film as described in (17) above; and

a polarizer.

(19) A liquid crystal display device comprising:

a liquid crystal cell; and

at least one of a hybrid film as described in any of (1) to (12) above, an optically compensatory film as described in (17) above and a polarizing plate as described in (18) above. In the invention, the following constitutions (20) to (27), too, are preferred.

(20) The optically compensatory film as described in (17) above,

wherein the optically anisotropic layer comprises a layer that comprises a discotic liquid crystal compound.

(21) The optically compensatory film as described in (17) above,

wherein the optically anisotropic layer comprises a layer that comprises a rod-shaped liquid crystal compound.

(22) The optically compensatory film as described in (17) above,

wherein the optically anisotropic layer comprises a polymer film.

(23) The optically compensatory film as described in (22) above,

wherein the polymer film comprises at least one polymer material selected from the group consisting of polyamide, polyimide, polyester, polyether ketone, polyamide imide polyester imide and polyaryl ether ketone.

(24) A polarizing plate comprising:

at least one of a hybrid film as described in any of (1) to (12) above and an optically compensatory film as described in any of (20) to (23) above; and

a polarizer.

(25) The polarizing plate as described in (18) or (24) above, which has at least one layer selected from the group consisting of a hard coat layer, an anti-glare layer and an anti-reflection layer.

(26) A liquid crystal display device comprising:

a liquid crystal cell; and

at least one of a hybrid film as described in any of (1) to (12) above, an optically compensatory film as described in any of (20) to (23) above and a polarizing plate as described in (24) and (25) above.

(27) A liquid crystal display device as described in (26) above, wherein the liquid crystal cell is of VA mode or IPS mode.

### BEST MODE FOR CARRYING OUT THE INVENTION

The hybrid film of the invention is characterized in that it comprises a cellulose acylate and a cycloolefin compound having a mass-average molecular mass of from 200 to 20,000. The hybrid film of the invention will be further described hereinafter.

### [Cellulose Acylate]

As the cellulose from which the cellulose acylate to be used in the hybrid film of cellulose acylate and cycloolefin compound of the invention is prepared there is used cotton linter, wood pulp (broad leaf pulp, conifer pulp) or the like. Any cellulose acylate obtained from these celluloses may be used. If necessary, these cellulose acylates may be used in admixture. From the standpoint of peelability, cotton linter is preferably used as cellulose from which the cellulose acylate is prepared. For the details of these celluloses as raw material, reference can be made to Maruzawa and Uda, “Purasuchikku Zairyo Koza (17)-Senisokeijushi (Institute of Plastic Materials (17)-Cellulose-based Resin)”, Nikkan Kogyo Shinbunsha, 1970 and Kokai Giho 2001-1745, Japan Institute of Invention and Innovation, pp. 7-8. The celluloses to be used in the hybrid film of the invention are not specifically limited.

### [Acyl Substituent in Cellulose Acylate]

The cellulose acylate to be used in the hybrid film of the invention prepared from the aforementioned cellulose as raw material will be described hereinafter. The cellulose acylate which is preferably used in the invention is a cellulose having its hydroxyl group acylated. The acyl group as substituent may range from acetyl group, which has two carbon atoms, to one having 22 carbon atoms. In the cellulose acylate of the invention, the degree of substitution of hydroxyl group in cellulose is not specifically limited. The degree of substitution can be determined by measuring the degree of bonding of acetic acid and/or C₃-C₂₂ aliphatic acid which replaces the hydroxyl group in cellulose and then subjecting the measurements to calculation. The measurement can be made according to ASTM D-817-91.

Among acetic acid and/or C₃-C₂₂ aliphatic acid which replaces the hydroxyl group in cellulose, the C₂-C₂₂ acryl group is not specifically limited and may be an aliphatic group or aryl group. These acyl groups may be used singly or in admixture. Examples of these acyl groups include alkylcarbonylester, alkenylcarbonylester, aromatic carbonylester and aromatic alkylcarbonylester of cellulose. These esters each may have substituted groups. Preferred examples of these acyl groups include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, and cinnamoyl. Preferred among these acyl groups are acetyl, propionyl, butanoyl, dodecanoyl, octadecanoyl, t-butanoyl, oleoyl, benzoyl, naphthylcarbonyl, and cinnamoyl. More desirable among these acyl groups are acetyl, propionyl, and butanoyl. Particularly preferred among these acyl groups are acetyl, propionyl, and butanoyl. The acyl substituent is preferably substantially composed of at least two groups selected from the group consisting of acetyl group, propionyl group and butanoyl group. It is particularly preferred that the acyl substituent be substantially composed of acetyl group and propionyl group.

### [Degree of Acyl Substitution in Cellulose Acylate]

As mentioned above, in the cellulose acylate to be used in the hybrid film of the invention, the degree of substitution of hydroxyl group in cellulose is not specifically limited, but the degree of substitution of hydroxyl group in cellulose by acyl is preferably from 2.0 to 3.0, more preferably from 2.2 to 3.0, even more preferably from 2.5 to 3.0.

As a result of extensive studies by the inventors, it was found that when the cellulose acylate to be used in the hybrid film of the invention is substantially substituted by only acetyl group among the aforementioned acyl substituents which replace the hydroxyl group in cellulose, the total degree of acyl substitution is preferably from 2.5 to 3.0, more preferably from 2.6 to 3.0, even more preferably from 2.7 to 3.0.

Further, when the cellulose acylate to be used in the hybrid film of the invention is substantially substituted by at least two groups selected from the group consisting of acetyl group, propionyl group and butanoyl group among the aforementioned acyl substituents which replace the hydroxyl group in cellulose, the total degree of acyl substitution is preferably from 2.0 to 3.0, more preferably from 2.2 to 3.0, even more preferably from 2.5 to 3.0.

Moreover, when the cellulose acylate to be used in the hybrid film of the invention is substantially substituted by acetyl group and propionyl group among the aforementioned acyl substituents which replace the hydroxyl group in cellulose, the total degree of acyl substitution is preferably from 2.0 to 3.0, more preferably from 2.2 to 3.0, even more preferably from 2.5 to 3.0.

### [Polymerization Degree of Cellulose Acylate]

The polymerization degree of the cellulose acylate which is preferably used in the hybrid film of the invention is from 180 to 700 as calculated in terms of viscosity-average polymerization degree. The polymerization degree of the cellulose acylate, if it is cellulose acetate, is preferably from 180 to 550, more preferably from 180 to 400, particularly preferably from 180 to 350. When the polymerization degree of the cellulose acylate is too high, the dope solution of cellulose acylate is too high to prepare a film by flow casting. When the polymerization degree of the cellulose acylate is too low, the film thus prepared exhibits a lowered strength. The average polymerization degree can be measured by the intrinsic viscosity method proposed by Uda et al (Kazuo Uda and Hideo Saito, “Journal of the Society of Fiber Science and Technology, Japan”, vol. 18, No. 1, pp. 105-120, 1962). For details of this method, reference can be made to JP-A-9-95538.

The molecular mass distribution of the cellulose acylate which is preferably used in the invention is evaluated by gel permeation chromatography. The cellulose acylate to be used herein preferably has a small polydispersibility index Mw/Mn (Mw: mass-average molecular mass; Mn: number-average molecular mass) and a sharp molecular mass distribution. In some detail, Mw/Mn is preferably from 2.0 to 4.0, more preferably from 2.0 to 3.5, most preferably from 2.3 to 3.3.

When low molecular components have been removed, the resulting cellulose acylate exhibits a raised average molecular mass (polymerization degree) but a lower viscosity than ordinary cellulose acylates and thus is useful. The cellulose acylate having little low molecular components can be obtained by removing low molecular components from a cellulose acylate synthesized by an ordinary method. The removal of low molecular components from a cellulose acylate can be carried out by washing the cellulose acylate with a proper organic solvent. In order to prepare a cellulose acylate having little low molecular components, it is preferred that the amount of a sulfuric acid catalyst to be used in acetylation reaction be adjusted to a range of from 0.5 to 25 parts by mass based on 100 parts by mass of cellulose. (In this specification, mass ratio is equal to weight ratio.) When the amount of a sulfuric acid catalyst falls within the above defined range, a cellulose acylate which is desirable also in molecular mass distribution (uniform molecular mass distribution) can be synthesized. The cellulose acylate of the invention preferably has a water content of 2% by mass or less, more preferably 1% by mass or less, particularly preferably 0.7% by mass or less. In general, a cellulose acylate contains water and is known to have a water content of from 2.5% to 5% by mass. In order to adjust the water content of the cellulose acylate of the invention to the above defined range, it is necessary that the cellulose acylate be dried. The drying method is not specifically limited so far as the desired water content can be attained. For the details of the cotton from which these cellulose acylates of the invention are prepared and their synthesis methods, reference can be made to Kokai Giho 2001-1745, Japan Institute of Invention and Innovation, pp. 7-12, Mar. 15, 2001.

The cellulose acylates of the invention may be used singly or in combination of two or more thereof so far as the substituents, the substitution degree, the polymerization degree, the molecular mass distribution, etc. fall within the above defined ranges.

### [Cycloolefin Compound]

The cycloolefin compound to be used in the hybrid film of the invention comprising a cellulose acylate and a cycloolefin compound may be a cycloolefin monomer or a resin obtained by the polymerization or copolymerization of cycloolefin monomers. Examples of the cycloolefin monomers employable herein include polycyclic unsaturated hydrocarbons and derivatives thereof such as norbornene, dicyclopentadiene, tetracyclododecene, ethyl tetracyclododecene, ethylidene tetracyclododecene and tetracyclo[7.4.0.1^{10,13}.0^{2,7}]trideca-2,4,6,11-tetraene, and monocyclic unsaturated hydrocarbons and derivatives thereof such as cyclobutene, cyclopentene, cyclohexene, 3,4-dimethylcyclopentene, 3-methylcyclohexene, 2-(2-methylbutyl)-1-cyclohexene, cyclooctene, 3a,5,6,7a-tetrahydro-4,7-metano-1H-indene, cycloheptene, cyclopentadiene and cyclohexadiene. These cycloolefin monomers may have polar groups as substituent. Examples of these polar groups include hydroxyl groups, carboxyl groups, alkoxyl groups, epoxy groups, glycidyl groups, oxycarbonyl groups, carbonyl groups, amino groups, ester groups, and carboxylic anhydride groups. Particularly preferred among these polar groups are ester groups, carboxyl groups and carboxylic anhydride groups.

The cycloolefin compound may be also obtained by the addition copolymerization of monomers other than cycloolefin monomer. Examples of the addition-copolymerizable monomers include ethylenes such as ethylene, propylene, 1-butene and 1-pentene, and dienes such as α-olefin, 1,4-hexadiene, 4-methyl-1,4-hexadiene, 5-methyl-1,4-hexadiene and 1,7-octadiene.

The polymer is obtained by addition polymerization reaction or ring opening metathesis polymerization reaction. The polymerization is effected in the presence of a catalyst. Examples of the addition polymerization catalyst employable herein include a polymerization catalyst comprising a vanadium compound and an organic aluminum compound. Examples of the ring opening polymerization catalyst employable herein include polymerization catalysts comprising a halide, nitrate or acetylacetone compound of a metal such as ruthenium, rhodium, palladium, osmium, iridium and platinum and a reducing agent, and polymerization catalysts comprising a halide or acetylacetone compound of a metal such as titanium, vanadium, zirconium, tungsten and molybdenum and an organic aluminum compound. The polymerization temperature, pressure, etc. are not specifically limited. In general, the polymerization is effected at a temperature of from 50° C. to 100° C. and a pressure of from 0 to 50 kgf/cm² (0 to 4.9 MPa).

The cycloolefin compound to be used in the invention is characterized by the mass-average molecular mass of from 200 to 20,000. Examples of the method for the production of a cycloolefin compound having a mass-average molecular mass falling within the above defined range include (i) method involving the use of a cycloolefin compound prepared by reducing the molecular mass of a thermoplastic norbornene-based resin, (ii) method involving the use of a cycloolefin compound obtained by properly polymerizing monomers, (iii) method involving the use of a cycloolefin compound having a molecular mass of from 200 to 3,000.

### [Molecular Mass of Cycloolefin Compound]

The cycloolefin compound to be used in the invention may be a monomer, may be obtained by previously polymerizing monomers to properly adjust the molecular mass thereof or may be obtained by reducing the molecular mass of a high molecular norbornene-based resin. Taking into account the conditions under which filming is effected, the (mass-average) molecular mass of the cycloolefin compound of the invention is from 200 to 20,000, preferably from 500 to 10,000, more preferably from 1,000 to 8,000 from the standpoint of formability during melt film forming and solubility in solvent during solution film forming. In the case where the cycloolefin compound of the invention is used in the form of monomer, its molecular mass is preferably from 200 to 3,000, more preferably from 250 to 2,000.

When the molecular mass of the cycloolefin compound is too great, the cycloolefin compound exhibits a deteriorated solubility in the solvent and a deteriorated compatibility with the cellulose acylate leading to raised haze, making it difficult to form a hybrid film which can be used as an optical film. When the molecular mass of the cycloolefin compound is too small, the properties of the cycloolefin compound can difficultly be reflected, making it difficult to develop physical properties suitable for hybrid film.

[Method for Obtaining Cycloolefin Compound from Polymer Resin]

As the cycloolefin compound constituting the hybrid film of the invention there may be preferably used also a thermoplastic norbornene-based resin. Examples of the thermoplastic norbornene-based resin employable herein include Zeonex and ZEONOR (produced by ZEON CORPORATION) and ARTON (produced by JSR Corporation). These thermoplastic norbornene-based resins have a high molecular mass as they are and thus can be little dissolved in the dope solution for solution film forming. It is thus important to adjust the molecular mass of these thermoplastic norbornene-based resins to the desired range by some method. For example, ultrasonic treatment using an ultrasonic radiator such as probe type sonicator is preferably used to reduce the molecular mass of these thermoplastic norbornene-based resins so that they can be dissolved in the dope solution of cellulose acylate. In accordance with this method, the ultrasonic strength and the treatment time can be properly adjusted to obtain cycloolefin compounds having various molecular mass. Thus, this method is very desirable in that a cycloolefin compound falling within the desired range can be easily obtained.

### [Method for Obtaining a Cycloolefin Compound by Crosslinking]

The cycloolefin compound to be used in the invention may have in its cycloolefin monomers a crosslinkable group that undergoes crosslinking reaction when irradiated with light or heated. In this case, a cycloolefin monomer may be previously dissolved in the solvent to be used in the dope solution. Subsequently, the cycloolefin compound is caused to undergo crosslinking in the solvent so that it is polymerized to obtain a polymer having a desired molecular mass which is then added to the dope solution to prepare a hybrid with cellulose acylate.

As the crosslinkable group to be added to the cycloolefin compound to be used in the invention there can be proposed a polymerizable unsaturated double bond group or an epoxy group. Examples of these cycloolefin compounds include cycloolefin compounds having an alkenyl group such as vinyl group and allyl group or an unsaturated aliphatic acid residue such as acryl acid residue and methacrylic acid residue, and cycloolefin compounds having an epoxy group.

In the hybrid film of the invention, the cycloolefin compound having a polymerizable unsaturated double bond group or epoxy group may be produced by thermal or ultraviolet polymerization without any initiator. If necessary, however, the polymerization may be effected in the presence of a radical polymerization catalyst such as azobisisobutylonitrile (AIBN) and benzoyl peroxide (BPO), an anionic polymerization catalyst or a cationic polymerization catalyst.

Preferred examples of the photopolymerization initiator employable herein include benzyl ketal derivatives such as benzoyl derivative and Irgacure 651, α-hydroxyacetophenone derivatives such as 1-hydroxy cyclohexylphenyl ketone (such as Irgacure 184), and α-aminoacetophenone derivatives such as Irgacure 907.

In the invention, the cycloolefin compound having a polymerizable unsaturated double bond group or epoxy group as crosslinkable group preferably has a plurality of substituents having such a polymerizable unsaturated double bond group or epoxy group particularly from the standpoint of reactivity.

These cycloolefin compounds having such a polymerizable unsaturated double bond group or epoxy group may be used singly or in admixture of two or more thereof.

In order to subject the cycloolefin compound having an unsaturated double bond group or epoxy group according to the invention to photopolymerization, as the energy radiation there may be used a means of emitting ultraviolet rays, for example. Examples of the ultraviolet ray emitting sources employable herein include low pressure mercury vapor lamp, middle pressure mercury vapor lamp, high pressure mercury vapor lamp, ultrahigh pressure mercury vapor lamp, xenon lamp, carbon arc, metal halide lamp, and sunlight. The photopolymerization by irradiation with ultraviolet rays can be effected in the air or inert gas. In the case where the cycloolefin compound having an unsaturated double bond group is used, the photopolymerization may be effected in the air. In order to reduce the induction period for polymerization, an atmosphere the oxygen concentration in which has been reduced as much as possible by purging with nitrogen is preferably used. The emission intensity of ultraviolet ray is preferably from about 0.1 to 200 mW/cm². The dose of ultraviolet ray is preferably from about 100 to 30,000 m^{J}/cm².

### [Mixing Ratio of Cellulose Acylate and Cycloolefin Compound]

The hybrid film comprising a cellulose acylate and a cycloolefin compound of the invention preferably has a cycloolefin compound incorporated in an amount of from 0.1 to 150% by mass, more preferably from 10 to 100% by mass, even more preferably from 20 to 80% by mass based on 100% by mass of cellulose acylate.

### (Humidity Dependence Improver)

The hybrid film of the invention also preferably comprises a humidity dependence improver described below incorporated therein to enhance the durability thereof.

The optical film of the invention preferably comprises a compound containing at least two hydrogen-bonding groups incorporated therein.

The compound containing at least two hydrogen-bonding groups is also referred to as “humidity dependence improver” herein.

The invention will be further described hereinafter with reference to the case where cellulose acylate, which is a suitable material constituting the optical film of the invention, is used by way of example.

The incorporation of a humidity dependence improver in the optical film of the invention makes it possible to improve the humidity dependence of in-plane retardation of the optical film. This is presumably attributed to the fact that the humidity dependence improver has two or more hydrogen-bonding groups that interact with the hydroxyl group in the cellulose acylate to form pseudo-crosslinking sites between the cellulose acylate chains, inhibiting the interaction of cellulose acylate with external water molecules.

It is therefore essential for the humidity dependence improver to have hydrogen-bonding groups for interacting with cellulose acylate. However, when the humidity dependence improver has so many hydrogen-bonding groups that it is too hydrophilic, the resulting optical film exhibits too high a water content and water permeability and thus forms a polarizing plate having a deteriorated moist heat resistance to disadvantage.

Therefore, the humidity dependence improver preferably has one or more aromatic rings to enhance the hydrophobicity thereof.

Most preferably, the humidity dependence improver has two to four hydrogen-bonding groups and one to three aromatic rings.

In the invention, the hydrogen-bonding group is a functional group having hydrogen atoms capable of forming hydrogen bond between the hydrogen atoms and other functional groups having a high electronegativity. Preferred examples of the hydrogen-bonding group of the invention include amino groups, acylamino groups, alkoxycarbonylamino groups, aryloxycarbonylamino groups, sulfonylamino groups, hydroxyl groups, mercapto groups, and carboxyl groups. Particularly preferred among these functional groups are hydroxyl groups, acylamino groups, and sulfoylamino groups.

In the invention, the humidity dependence improver is preferably incorporated in the cellulose acylate film in an amount of from 1% to 30%, more preferably from 5% to 20%, particularly preferably from 7% to 16%.

The humidity dependence improver according to the invention preferably has a molecular weight of from not smaller than 250 to not greater than 2,000 and a boiling point of not lower than 260° C. For the measurement of the boiling point of the humidity dependence improver, a commercially available measuring instrument (e.g., Type TG/DTA100, produced by SEIKO EPSON CORPORATION) may be used.

As the humidity dependence improver of the invention there may be used any of various compounds. A compound represented by the following formula (A) is preferably used.

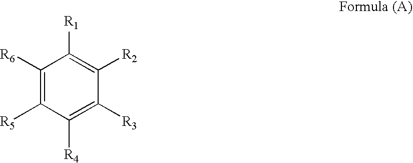

wherein R₁, R₂, R₃, R₄, R₅ and R₆ each represent a hydrogen atom or substituent, with the proviso that at least two of R₁, R₂, R₃, R₄, R₅ and R₆ each are a hydrogen-bonding group. As the substituent there may be used the following substituent T.

Examples of the substituent T include alkyl groups (preferably a C₁-C₂₀, more preferably a C₁-C₁₂, particularly preferably a C₁-C₈ alkyl group, e.g., methyl, ethyl, iso-propyl, tert-butyl, n-octyl, n-decyl, n-hexadecyl, cyclopropyl, cyclopentyl, cyclohexyl), alkenyl groups (preferably a C₂-C₂₀, more preferably a C₂-C₁₂, particularly preferably a C₂-C₈ alkenyl group, e.g., vinyl, allyl, 2-butenyl, 3-pentenyl), alkynyl groups (preferably a C₂-C₂₀, more preferably a C₂-C₁₂, particularly preferably a C₂-C₈ alkynyl group, e.g., propargyl, 3-pentynyl), aryl groups (preferably a C₆-C₃₀, more preferably a C₆-C₂₀, particularly preferably a C₆-C₁₂ aryl group, e.g., phenyl, p-methylphenyl, naphthyl), substituted or unsubstituted amino groups (preferably a C₀-C₂₀, more preferably a C₀-C₁₀, particularly preferably a C₀-C₆ amino group, e.g., amino, methylamino, dimethylamino, diethylamino, dibenzylamino), alkoxy groups (preferably a C₁-C₂₀, more preferably a C₁-C₁₂, particularly preferably a C₁-C₈ alkoxy group, e.g., methoxy, ethoxy, butoxy), aryloxy groups (preferably a C₆-C₂₀, more preferably a C₆-C₁₆, particularly preferably a C₆-C₁₂ aryloxy group, e.g., phenyloxy, 2-naphthyloxy), acyl groups (preferably a C₁-C₂₀, more preferably a C₁-C₁₆ acyl group, particularly preferably a C₁-C₁₂ acyl group, e.g., acetyl, benzoyl, formyl, pivaloyl), alkoxycarbonyl groups (preferably a C₂-C₂₀, more preferably a C₂-C₁₆, particularly preferably a C₂-C₁₂ alkoxycarbonyl group, e.g., methoxycarbonyl, ethoxycarbonyl), aryloxycarbonyl groups (preferably a C₇-C₂₀, more preferably a C₇-C₁₆, particularly preferably a C₇-C₁₀ aryloxycarbonyl group, e.g., phenyloxycarbonyl), acyloxy groups (preferably a C₂-C₂₀, more preferably a C₂-C₁₆, particularly preferably a C₂-C₁₀ acyloxy group, e.g., acetoxy, benzoyloxy), acylamino groups (preferably a C₂-C₂₀, more preferably a C₂-C₁₆, particularly preferably a C₂-C₁₀ acylamino group, e.g., acetylamino, benzoylamino), alkoxycarbonylamino groups (preferably a C₂-C₂₀, more preferably a C₂-C₁₆, particularly preferably a C₂-C₁₂ alkoxycarbonylamino group, e.g., methoxycarbonylamino), aryloxycarbonyl amino groups (preferably a C₇-C₂₀, more preferably a C₇-C₁₆, particularly preferably a C₇-C₁₂ aryloxycarbonylamino group, e.g., phenyloxycarbonylamino), sulfonylamino groups (preferably a C₁-C₂₀, more preferably a C₁-C₁₆, particularly preferably a C₁-C₁₂ sulfonylamino group, e.g., methanesulfonylamino, benzenesulfonylamino), sulfamoyl groups (preferably a C₀-C₂₀, more preferably a C₀-C₁₆, particularly preferably a C₀-C₁₂ sulfamoyl group, e.g., sulfamoyl, methylsulfamoyl, dimethylsulfamoyl, phenylsulfamoyl), carbamoyl groups (preferably a C₁-C₂₀, more preferably a C₁-C₁₆, particularly preferably a C₁-C₁₂ carbamoyl group, e.g., carbamoyl, methyl carbamoyl, diethyl carbamoyl, phenyl carbamoyl), alkylthio groups (preferably a C₁-C₂₀, more preferably a C₁-C₁₆, particularly preferably a C₁-C₁₂ alkylthio group, e.g., methylthio, ethylthio), arylthio groups (preferably a C₆-C₂₀, more preferably a C₆-C₁₆, particularly preferably a C₆-C₁₂ arylthio group, e.g., phenylthio), sulfonyl groups (preferably a C₁-C₂₀, more preferably a C₁-C₁₆, particularly preferably a C₁-C₁₂ sulfonyl group, e.g., mesyl, tosyl), sulfinyl groups (preferably a C₁-C₂₀, more preferably a C₁-C₁₆, particularly preferably a C₁-C₁₂ sulfinyl group, e.g., methanesulfinyl, benzenesulfinyl), ureido groups (preferably a C₁-C₂₀, more preferably a C₁-C₁₆, particularly preferably a C₁-C₁₂ ureido group, e.g., ureido, methylureido, phenylureido), phosphoric acid amide groups (preferably a C₁-C₂₀, more preferably a C₁-C₁₆, particularly preferably a C₁-C₁₂ phosphoric acid amide group, e.g., amide diethylphosphate, amide phenylphosphate), hydroxyl groups, mercapto groups, halogen atoms (e.g., fluorine, chlorine, bromine, iodine), cyano groups, sulfo groups, carboxyl groups, nitro groups, hydroxamic acid groups, sulfino groups, hydrazino groups, imino groups, heterocyclic groups (preferably a C₁-C₃₀, more preferably a C₁-C₁₂ heterocyclic group having nitrogen atom, oxygen atom or sulfur atom as hetero atom, e.g., imidazolyl, pyridyl, quinolyl, furyl, piperidyl, morpholino, benzooxazolyl, benzimidazolyl, benzthiazolyl), and silyl groups (preferably a C₃-C₄₀, more preferably a C₃-C₃₀, particularly preferably a C₃-C₂₄ silyl group, e.g., trimethylsilyl, triphenylsilyl). More desirable among these substituents are alkyl groups, aryl groups, substituted or unsubstituted amino groups, alkoxy groups, and aryloxy groups. Even more desirable among these substituents are alkyl groups, aryl groups, and alkoxy groups.

These substituents may be further substituted by substituents T. Two or more of these substituents, if any, may be the same or different. If possible, these substituents may be connected to each other to form a ring.

At least two of R₁, R₂, R₃, R₄, R₅ and R₆ each are a substituted or unsubstituted amino group, acylamino group, alkoxycarbonylamino group, aryloxycarbonylamino group, sulfonylamino group, hydroxyl, group, mercapto group or carboxyl group, preferably a substituted or unsubstituted amino group or hydroxyl group, particularly preferably a substituted or unsubstituted hydroxyl group. The substituents on these groups may be the same or different.

Particularly preferred examples of the compound represented by the formula (A) which is preferably used in the invention will be shown below, but the invention is not limited thereto.

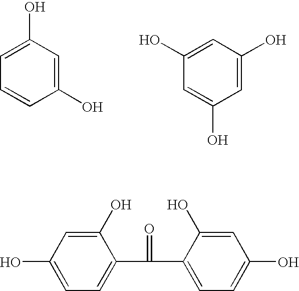

### [Other Additives]

The hybrid film comprising a cellulose acylate and a cycloolefin compound of the invention may properly have a plasticizer, an optical anisotropy adjustor, a wavelength dispersion adjustor, an ultraviolet absorbent, an infrared absorbent, a light stabilizer, a heat stabilizer, an oxidation inhibitor, a dispersant, a particulate material, a peeling agent, a dye, a pigment, a deterioration inhibitor, a fluorescent brightener, an antistatic agent or the like incorporated therein as necessary. The dope solution to be used in the solution film formation of the hybrid film of the invention may have the aforementioned additives dissolved therein depending on the purpose at various preparation steps. The addition of these additives may be effected at any stages during the preparation of the dope solution. However, a step of adding these additives may be added to the final preparation step during the preparation of the dope solution.

### [Added Amount of Other Additives]

During this procedure, the other additives are preferably added in an amount of from 5 to 45% by mass, more preferably from 10 to 40% by mass, even more preferably from 15 to 30% by mass based on 100% by mass of the cellulose acylate. When the total amount of the other additives falls below 5% by mass, the properties of simple body of cellulose acylate can easily be developed, making it more likely that the resulting hybrid film can be more subject to fluctuation of optical properties or physical strength with the change of temperature or humidity. When the total amount of the other additives exceeds 45% by mass, it is beyond the limit of compatibilization of these additives with the hybrid film. Thus, these additives can be easily separated out on the surface of the film to cause clouding of the film (bleeding from film).

### [Molecular Mass of Other Additives]

The aforementioned additives are normally low molecular compounds. In order to prepare the hybrid film of the invention, these additives are preferably compounds having a molecular mass of 3,000 or less, more preferably 2,500 or less, even more preferably 2,000 or less.

### [Melt Film Forming]

The preparation of the hybrid film of the invention may be carried out by melt film forming. Raw materials such as cellulose acylate, cycloolefin compound and additives may be heat-melted, and then extruded to form a film. Alternatively, these raw materials may be pressed between two sheets of heated plates to form a film.

The temperature at which heat melting is effected is not specifically limited so far as the cellulose acylate and cycloolefin compound which are raw materials can be uniformly melted altogether. In some detail, these raw materials are heated to a temperature of not lower than the melting point or softening point thereof. In order to obtain a uniform film, these raw materials are preferably heated and melted at a temperature of higher than the melting point of the cellulose acylate and cycloolefin compound, more preferably from 5° C. to 40° C. higher than the melting point of the cellulose acylate and cycloolefin compound, particularly preferably from 8° C. to 30° C. higher than the melting point of the cellulose acylate and cycloolefin compound.

### [Solution Film Forming]

The preparation of the hybrid film of the invention is also preferably carried out by dissolving a cellulose acylate, a cycloolefin compound, additives, etc. in a solvent, and then subjecting the solution to solution film forming. Solution film forming can be employed as an excellent film forming method particularly from the standpoint of improvement of surface conditions of film. The detailed method of solution film forming is not specifically limited so far as it involves casting on a support substrate having a surface smoothness such as metallic sheet. In some detail, the dope solution may be spread directly over the support substrate to form a film. Alternatively, a method such as flow casting using a die and coating using a blade may be properly employed. The removal of the solvent by drying can be effected at room temperature or under heating depending on the melting point of the solvent used. The heat drying may be effected at a temperature of from 30° C. to 200° C. for about 5 minutes to 2 hours without any wind or in an air flow depending on the predetermined drying conditions.

Detailed examples of the solution film forming method for the production of the hybrid film of the invention include a related art solution flow casting film forming method and apparatus for the production of a cellulose acetate film for liquid crystal display device. The method and apparatus will be further described hereinafter.

In order to produce the hybrid film of the invention by a solution film forming method, a solution (dope) having a cellulose acylate and a cycloolefin compound uniformly dissolved therein is used to form a film. As the organic solvent which is preferably used as a main solvent for the hybrid film of the invention there is preferably used a solvent selected from the group consisting of C₃-C₁₂ ester, ketone and ether and C₁-C₇ halogenated hydrocarbon. The ester, ketone and ether may have a cyclic structure. A compound having two or more of functional groups in ester, ketone and ether (i.e., —O—, —CO—, —COO—) may be used as a main solvent. The solvent may have other functional groups such as alcoholic hydroxyl group. The number of carbon atoms in the main solvent having two or more functional groups may fall within the range defined for compound having any of these functional groups.

### [Dissolving Step]

In the method for the preparation of the solution (dope) of the hybrid film of the invention, the dissolving method is not specifically limited. The dissolution of the raw materials may be effected at room temperature. Alternatively, the dissolution of the raw materials may be effected by either or both of a cold dissolving method or a hot dissolving method. The preparation of the hybrid film solution of the invention, the solution concentration involved in the dissolving step and the filtration may be carried out according to the method for dissolving cellulose acylate film. The production method described in detail in Kokai Giho 2001-1745, Japan Institute of Invention and Innovation, pp. 22-25, Mar. 15, 2001, can be preferably employed.

### [Transparency of Dope Solution]

The transparency of the hybrid film dope solution of the invention is preferably 85% or more, more preferably 88% or more, even more preferably 90% or more. It was confirmed that the dope solution of the hybrid film of the invention has various additives sufficiently dissolved therein besides the cellulose acylate and the cycloolefin compound. Referring in detail to the method for calculating the dope transparency, a glass cell having a size of 1 cm square filled with the dope solution was measured for absorbance at 550 nm using a Type UV-3150 spectrophotometer (produced by Shimadzu Corporation). The solvent alone had been previously measured for absorbance as a blank. The transparency of the cellulose acylate solution was then calculated from the ratio of absorbance of the dope solution to absorbance of the blank.

### [Flow Casting]

The hybrid film of the invention will be further described with reference to the solution film forming method. As the method and apparatus for the production of the hybrid film of the invention there are preferably used related art solution flow casting film forming method and apparatus for use in the production of cellulose acetate film. In some detail, the dope (solution of cellulose acylate and cycloolefin compound) prepared in the dissolving machine (kiln) is stored in a storage vessel in which it is then defoamed to obtain a final product. The dope is then supplied from the dope discharging outlet into a pressure die through, e.g., a pressure metering pump capable of precisely feeding a solution at a constant rate by the rotary speed. The dope is then uniformly casted from the slit of the pressure die over the metallic support of the flow casting portion which is running endlessly. When the metallic support makes almost one turn, the half-dried dope film (also called web) is then peeled off the metallic support at the peeling point.

### [Drying, Winding]

The web thus obtained is dried while being conveyed by a tenter with the both edges thereof caught by a clip and the width thereof kept constant. Subsequently, the web is conveyed over the roll block in the drying apparatus to finish drying. The web is then wound over a predetermined length using a winding machine. The combination of the tenter and the roll block constituting the drying apparatus depends on the purpose.

### [Amount of Residual Solvent in Film]

In the case where the hybrid film of the invention is obtained by a solution film forming method, drying is preferably effected under the conditions such that the amount of residual solvent reaches a range of from 0.01 to 1.5% by mass, more preferably from 0.01 to 1.0% by mass. The amount of residual solvent can be represented by the following equation.

Amount of residual solvent (% by mass)={(M−N)/N}×100

wherein M represents the mass of the web at arbitrary time; and N represents the mass of the web dried at 110° C. for 3 hours.

### [Thickness of Hybrid Film]

The thickness of the hybrid film of the invention is preferably from 20 μm to 200 μm, more preferably from 40 μm to 180 μm, even more preferably from 60 μm to 150 μm from the standpoint of appropriateness for protective film for polarizing plate or producibility.

### [Haze of Film]

The haze of the hybrid film of the invention is preferably from 0.01% to 5.0%, more preferably from 0.01% to 2.5%, even more preferably from 0.01% to 1.5%, particularly preferably from 0.01% to 1.0%. The film transparency is important for optical film. For the measurement of haze, a hybrid film sample having a size of 40 mm×80 mm of the invention was measured at 25° C. and 60% RH using a Type HGM-2DP haze meter (produced by Suga Test Instrument Co., Ltd.) according to JIS K-6714.

### [Glass Transition Temperature Tg of Film]

The glass transition temperature Tg of the hybrid film of the invention is preferably from 80° C. to 165° C., more preferably from 100° C. to 165° C., particularly preferably from 110° C. to 165° C. from the standpoint of heat resistance. For the measurement of glass transition temperature Tg, 10 mg of the hybrid film sample of the invention was measured for calorie at a temperature rising/falling rate of 5° C./min from room temperature to 200° C. using a Type DSC2910 differential scanning calorimeter (produced by T. A. Instrument Co., Ltd.). From the measurements was then calculated glass transition temperature Tg.

### [Retention of Film]

In the hybrid film of the invention, the various components in the film are required to retain. In some detail, when the hybrid film of the invention is allowed to stand at 80° C. and 90% RH for 48 hours, the film preferably shows a mass change of from 0% to 5%, more preferably from 0% to 3%, even more preferably from 0% to 2%.

### [Moisture Permeability]

The hybrid film of the invention preferably satisfies the following relationship (1), more preferably the following relationship (1′), even more preferably the following relationship (1″).

A/B≦0.98 (1)

A/B≦0.95 (1′)

A/B≦0.93 (1″)

wherein A represents the moisture permeability of the hybrid film; and B represents the moisture permeability of the film prepared from only the cellulose acylate contained in the hybrid film.

The moisture permeability of the hybrid film of the invention is measured at a temperature of 60° C. and a humidity of 95% RH according to JIS Z0208. The moisture permeability of the hybrid film is preferably from 400 to 2,000 g/m²·24h, more preferably from 500 to 1,800 g/m²·24h, particularly preferably from 600 to 1,600 g/m²·24h as calculated in equivalence of thickness of 80 μm. When the moisture permeability of the hybrid film exceeds 2,000 g/m²·24h, the resulting hybrid film shows a strong tendency for lower durability. On the other hand, when the moisture permeability of the hybrid film falls below 400 g/m²·24h, the resulting hybrid film prevents the drying of the adhesive with which it is stuck to the both sides of a polarizer made of a polyvinyl alcohol to prepare a polarizing plate, causing maladhesion.

The more the thickness of the hybrid film of the invention is, the smaller is the moisture permeability of the hybrid film of the invention. The less the thickness of the hybrid film of the invention is, the greater is the moisture permeability of the hybrid film of the invention. Thus, how much thick the sample is, calculation needs to be effected in equivalence of thickness of 80 μm. The calculation of moisture permeability was made by the equation (moisture permeability in equivalence of thickness of 80 μm=measured moisture permeability×measured thickness (μm)/80 μm).

For the details of method for the measurement of moisture permeability employable herein, reference can be made to “Kobunshi no Bussei II (Polymer Physical Properties II)”, Kobunshi Jikken Koza 4, Kyoritsu Shuppan, pp. 285-294: Measurement of Vapor Permeability (mass method, thermometer method, vapor pressure method, adsorption method). The hybrid film having a size of 70 mmφ of the invention was moisture-conditioned at 25° C. and 90% RH for 24 hours and at 60° C. and 95% RH for 24 hours, and then calculated for water content (g/m²) per unit area according to JIS Z-0208 using a Type KK-709007 moisture permeability testing machine (produced by Toyo Seiki Seisaku-Sho, Ltd.). The moisture permeability of the hybrid film was then determined by the equation (moisture permeability)=(mass after moisture conditioned)−(mass before moisture conditioned).

### [Elastic Modulus of Film]

The hybrid film of the invention preferably satisfies the following relationship (2), more preferably the following relationship (2′), more preferably following relationship (2″).

0.5≦C/D≦1.5 (2)

0.6≦C/D≦1.4 (2′)

0.7≦C/D≦1.3 (2″)

wherein C represents the elastic modulus of the hybrid film; and D represents the elastic modulus of the film prepared from only the cellulose acylate contained in the hybrid film.

The elastic modulus of the hybrid film of the invention is preferably from 200 to 500 kgf/mm² (1.96 to 4.90 GPa), more preferably from 240 to 470 kgf/mm² (2.35 to 4.61 GPa), still more preferably from 270 to 440 kgf/mm² (2.65 to 4.31 GPa) from the standpoint of appropriateness for protective film for polarizing plate. In some detail, the hybrid film sample of the invention was measured for stress-elongation curve at a pulling rate of 10%/min and 0.5% elongation in a 25° C.-60% atmosphere using a Type STM T50BP versatile tensile testing machine (produced by Toyo Baldwin Co., Ltd.). The elastic modulus of the hybrid film of the invention was then determined from the inclination of the stress-elongation curve.

### [Tensile Elongation at Break]

The hybrid film of the invention preferably satisfies the following relationship (3), more preferably the following relationship (3′), more preferably following relationship (3″).

0.5≦E/F≦1.5 (3)

0.6≦E/F≦1.4 (3′)

0.7≦E/F≦1.3 (3″)

wherein E represents the tensile elongation at break (%) of the hybrid film; and F represents the tensile elongation at break (%) of the film prepared from only the cellulose acylate contained in the hybrid film.

The tensile elongation at break of the hybrid film of the invention is preferably from 5% to 100%, more preferably from 5% to 80%, even more preferably from 5% to 50% from the standpoint of appropriateness for protective film for polarizing plate. In some detail, supposing that the length of the film before stretched is L0 and the length of the film at break is L, the elongation at break (%) was determined by (L−L0)/L0×100.

### [Photoelastic Coefficient]

The hybrid film of the invention preferably satisfies the following relationship (4), more preferably the following relationship (4′), more preferably following relationship (4″).

G/H≦0.98 (4)

G/H≦0.95 (4′)

G/H≦0.90 (4″)

wherein G represents the photoelastic coefficient of the hybrid film; and H represents the photoelastic coefficient of the film prepared from only the cellulose acylate contained in the hybrid film.

The photoelastic modulus of the hybrid film of the invention is preferably from 50×10⁻¹³ cm²/dyne (5×10⁻¹³ N/m²) or less, more preferably 30×10⁻¹³ cm²/dyne (3×10⁻¹³ N/m²) or less, even more preferably 20×10⁻¹³ cm²/dyne (2×10⁻¹³ N/m²) or less, particularly preferably 10×10⁻¹³ cm²/dyne (1×10⁻¹³ N/M²) or less. In some detail, the hybrid film sample having a size of 12 mm×120 mm was measured for retardation at 632.8 nm while being given a longitudinal tensile stress using a Type M150 ellipsometer (produced by JASCO Corporation). From the change of retardation with stress was then calculated photoelastic coefficient.

### [Dimensional Change of Film]

The hybrid film of the invention preferably satisfies the following relationship (5), more preferably the following relationship (5′), more preferably following relationship (5″).

I/J≦0.98 (5)

I/J≦0.95 (5′)

I/J≦0.90 (5″)

wherein I represents the dimensional change (absolute value) (%) of the hybrid film; and J represents the dimensional change (absolute value) (%) of the film prepared from only the cellulose acylate contained in the hybrid film.

The percent dimensional change is a value developed after 24 hours of aging at 60° C.-90% RH. The percent dimensional change preferably fluctuates within ±0.5%, more preferably ±0.4%, even more preferably ±0.3%, particularly preferably ±0.1%.

In some detail, a hybrid film sample having a size of 30 mm×120 mm of the invention was prepared. The hybrid film sample was then moisture-conditioned at 25° C. and 60% RH for 24 hours. The hybrid film sample thus moisture-conditioned was then perforated on the both edges thereof with a hole having a diameter of 6 mmφ at an interval of 100 mm by an automatic pin gage (manufactured by Shinto Scientific Co., Ltd.). The interval of these holes was defined to be the original dimension (L0). The sample thus perforated was treated at 60° C. and 90% RH for 24 hours, and then measured for the interval of holes (L1). All these intervals were measured to a minimum scale of 1/1000 mm. Thus, the dimensional change at 60° C. and 90% RH was determined by the equation {(L0−L1)/L0}×100.

The adjustment of the aforementioned moisture permeability, elastic modulus, tensile elongation at break, photoelastic coefficient and dimensional change can be made by adjusting the mixing ratio of cellulose acylate and cycloolefin compound.

### [Optically Compensatory Film]

The hybrid film of the invention can be used for various purposes. The hybrid film of the invention can exert its effect particularly when used as an optically compensatory film for liquid crystal display device. An optically compensatory film is an optical material which is normally used in liquid crystal display devices to compensate the retardation thereof and is synonymous with retardation plate, optically compensatory sheet, etc. An optically compensatory film is birefringent and thus is used for the purpose of decoloring the display screen of liquid crystal display device or improving the viewing angle properties thereof.

Accordingly, in the case where the hybrid film of the invention is used as an optically compensatory film for liquid crystal display device, the retardation Re of the optically anisotropic layer to be used in combination therewith is preferably from 0 nm to 200 nm. Any optically anisotropic layer may be used so far as it has a retardation value falling within the above defined range. The retardation Re is obtained by moisture-conditioning a sample having a size of 30 mm×40 mm at 25° C. and 60% RH for 2 hours, and then measuring the sample thus moisture-conditioned for retardation with light having a wavelength of 589 nm incident thereon in the direction normal to the film using a Type KOBRA 21ADH automatic birefringence meter (produced by Ouji Scientific Instruments Co., Ltd.). The retardation value as used herein is measured at this wavelength unless otherwise specified. The hybrid film of the invention can be combined with any optically anisotropic layer required as optically compensatory film without being limited by the optical properties or driving system of the liquid crystal cell in the liquid crystal display device comprising the hybrid film of the invention. The optically anisotropic layer which can be combined with the hybrid film of the invention may be formed by a composition containing a liquid crystal compound or a birefringent polymer film. The aforementioned liquid crystal compound is preferably a discotic liquid crystal compound or rod-shaped liquid crystal compound.

### [Discotic Liquid Crystal Compound]

Examples of the discotic liquid crystal compound which can be used in the invention include compounds disclosed in various references (C. Destrade et al., “Mol. Crysr. Liq. Cryst.”, vol. 71, page 111, 1981; “Quarterly Review of Chemistry”, The Chemical Society of Japan, No. 22, “Ekisho no Kagaku (Chemistry of Liquid Crystals)”, Chapter 5, Section 2 of Chapter 10, 1994; B. Kohne et al., “Angew. Chem. Soc. Chem. Comm.”, page 1794, 1985; J. Zhang et al., “J. Am. Chem. Soc.”, vol. 116, page 2655, 1994).

The optically anisotropic layer preferably has discotic liquid crystal molecules fixed aligned therein. Most preferably, these discotic liquid crystal molecules have been fixed by polymerization reaction. For the polymerization of discotic liquid crystal molecules, reference can be made to JP-A-8-27284. In order to fix discotic liquid crystal molecules by polymerization, it is necessary that a polymerizable group be connected as a substituent to the disc-shaped core of the discotic liquid crystal molecules. However, when a polymerizable group is connected directly to the disc-shaped core of the discotic liquid crystal molecules, the discotic liquid crystal molecules can be difficultly kept aligned in the polymerization reaction. In order to avoid this trouble, a connecting group is incorporated in between the disc-shaped core and the polymerizable group. For the details of discotic liquid crystal molecules having a polymerizable group, reference can be made to JP-A 2001-4387.

### [Rod-Shaped Liquid Crystal Compound]

Examples of the rod-shaped liquid crystal compound employable herein include azomethines, azoxys, cyanobiphenyls, cyanophenylesters, benzoic acid esters, cyclohexanecarboxylic acid phenyl esters, cyanophenyl cyclophexanes, cyano-substituted phenylpyrimdines, alkoxy-substituted phenylpyrimidines, phenyldioxanes, tolans, and alkenyl cyclohexylbenzonitriles. Not only the aforementioned low molecular liquid crystal compounds but also polymer liquid crystal compounds can be used.

The optically anisotropic layer preferably has rod-shaped liquid crystal molecules fixed aligned therein. Most preferably, these rod-shaped liquid crystal molecules have been fixed by polymerization reaction.

Examples of the polymerizable rod-shaped liquid crystal compounds employable herein include compounds disclosed in “Makromol. Chem.”, vol. 190, page 2,255, 1989, “Advanced Materials”, vol. 5, page 107, 1993, U.S. Pat. Nos. 4,683,327, 5,622,648 and 5,770,107, WO95/22586, WO95/24455, WO97/00600, WO98/23580, WO98/52905, JP-A-1-272551, JP-A-6-16616, JP-A-7-110469, JP-A-11-80081, and JP-A-2001-328973.

### [Optically Anisotropic Layer Made of Polymer Film]

As mentioned above, the optically anisotropic layer may be formed by a polymer film. The polymer film is formed by a polymer capable of developing optical anisotropy. Examples of such a polymer include polyolefins (e.g., polyethylene, polypropylene, norbornene-based polymer), polycarbonates, polyacrylates, polysulfones, polyvinyl alcohols, polymethacrylic acid esters, polyacrylic acid esters, and cellulose esters (e.g., cellulose triacetate, cellulose diacetate). A copolymer or mixture of these polymers may be used.

The optical anisotropy of the polymer film is preferably obtained by stretching. The stretching of the polymer film is preferably effected monoaxially or biaxially. In some detail, monoaxial longitudinal stretching utilizing the difference in circumferential speed between two or more rolls or tenter stretching involving crosswise stretching with the both sides of the polymer film gripped by the tenter is preferably employed. Alternatively, biaxial stretching involving the two stretching methods in combination is preferably employed. Two or more sheets of polymer film may be used so far as the entire optical properties thereof satisfy the aforementioned requirements. The polymer film is preferably produced by solvent casting method to eliminate unevenness in birefringence. The thickness of the polymer film is preferably from 20 μm to 500 μm, most preferably from 40 μm to 100 μm.

There is preferably used also a method which comprises dissolving at least one polymer material selected from the group consisting of polyamide, polyimide, polyester, polyether ketone, polyamide imide, polyesterimide and polyaryl ether ketone as the polymer film forming the optically anisotropic layer in a solvent, spreading the solution thus obtained over a substrate, and then drying the coat layer to form a film. The polymer film and the substrate may be stretched to develop optical anisotropy. The film thus stretched can thus be used as an optically anisotropic layer. The hybrid film of the invention can be preferably used as the aforementioned substrate. Alternatively, the aforementioned polymer film may be prepared on a substrate different from the hybrid film of the invention, peeled off the substrate, and then stuck to the hybrid film of the invention to form an optically anisotropic layer. This method makes it possible to reduce the polymer film. In this case, the thickness of the polymer film is preferably 50 μm or less, more preferably from 1 μm to 20 μm.

### [Polarizing Plate]

The hybrid film of the invention is useful particularly as a protective film for polarizing plate. In the case where the hybrid film of the invention is used as a protective film for polarizing plate, the method for the preparation of the polarizing plate is not specifically limited. The polarizing plate can be prepared by any ordinary method. There may be used a method which comprises subjecting the hybrid film thus obtained to alkaline treatment, and then sticking the hybrid film to the both surfaces of a polarizer prepared by dipping and stretching a polyvinyl alcohol film (PVA) in an iodine solution with an aqueous solution of a fully saponified polyvinyl alcohol. The alkaline treatment may be replaced by adhesion processing disclosed in JP-A-6-94915 and JP-A-6-118232. In the case where the hybrid film of the invention is used as an optically compensatory film, the hybrid film may be subjected to alkaline treatment also on the surface thereof on which it is stuck to the polarizer before being stuck directly to the polarizer. Alternatively, the optically compensatory film may be stuck with an adhesive to a polarizing plate which has been already prepared by sticking a protective film to the both surfaces of a polarizer.

Examples of the adhesive with which the treated surface of the protective film is stuck to the polarizer include polyvinyl alcohol-based adhesives such as polyvinyl alcohol and polyvinyl butyral, and vinyl-based latexes such as butyl acrylate.

A liquid crystal display device normally comprises a substrate containing a liquid crystal (liquid crystal cell) disposed interposed between two sheets of polarizing plates. However, the protective film for the polarizing plate to which the hybrid film of the invention is applied may be disposed at any site.

### [Functional Layer]

In the case where the hybrid film of the invention is used in a liquid crystal display device as a protective film for polarizing plate, the hybrid film may be provided with various functional layers on the surface thereof. Examples of these functional layers include cured resin layer (transparent hard coat layer), anti-glare layer, anti-reflection layer, adhesive layer, optically compensatory layer, alignment layer, liquid crystal layer, and antistatic layer. Examples of these functional layers which can be used in the hybrid film of the invention and their materials include surface active agents, lubricants, matting agents, antistatic layers, and hard coat layers. For details, reference can be made to Kokai Giho 2001-1745, Japan Institute of Invention and Innovation, pp. 32-45, Mar. 15, 2001. These functional layers and materials can be preferably used in the invention.

### [Liquid Crystal Display Device]

The hybrid film of the invention and the optically compensatory film and polarizing plate comprising same can be applied to liquid crystal display devices of various display modes. As representative display modes there have been proposed various display modes such as IPS (In-Plane Switching), VA (Vertically Aligned), TN (Twisted Nematic), OCB (Optically Compensatory Bend), STN (Super Twisted Nematic), ECB (Electrically Controlled Birefringence), FLC (Ferroelectric Liquid Crystal), AFLC (Anti-ferroelectric Liquid Crystal), and HAN (Hybrid Alignment Nematic). There has also been proposed display modes obtained by domain division. The effect of the film having improved physical properties of the invention is remarkable particularly for large screen liquid crystal display devices. In this respect, the hybrid film of the invention is particularly preferably used for VA mode or IPS mode liquid crystal display devices for use in large-sized TV.

### EXAMPLE

The invention will be further described in the following examples, but the invention is not limited thereto.

### Example 1

100 parts by mass of a cellulose acetate having an acetyl substitution degree of 2.86, 400 parts by mass of methylene chloride and 60 parts by mass of methanol were charged into a mixing tank where they were then stirred and dissolved to prepare a cellulose acylate solution 1.

100 parts by mass of ZEONOR (ZF-14, produced by ZEON CORPORATION), which is a thermoplastic norbornene-based resin, were dissolved in 400 parts by mass of methylene chloride. The solution thus obtained was then subjected to intermittent supersonic treatment for 20 minutes (20 repetitions of irradiation for 30 seconds and standing for 30 seconds) using a probe type sonicator to obtain a mass-average molecular mass of 12,000. Thus, a solution 2 containing such a cycloolefin compound was obtained. The solutions 1 and 2 were then mixed in the equal part. As a result, a uniform dope solution having a transparency of 90% or more was obtained. The mixed solution was then casted over a metallic support to obtain a hybrid film 001 having a size of 60 cm×60 cm and a thickness of 80 μm.

### Example 2

A hybrid film 002 having a thickness of 80 μm was prepared in the same manner as in Example 1 except that ultrasonic irradiation was effected intermittently for 40 minutes (40 repetitions of irradiation for 30 seconds and standing for 30 seconds) to obtain a mass-average molecular mass of 4,500.

### Example 3

A hybrid film 003 having a thickness of 80 μm was prepared in the same manner as in Example 1 except that ZEONOR was replaced by ARTON (produced by JSR Corporation), which is a thermoplastic norbornene-based resin, and ultrasonic irradiation was effected to obtain a mass-average molecular mass of 8,000.

### Example 4

50 parts by mass of the following cycloolefin compound A and 3 parts by mass of Irgacure 907 (produced by Ciba Geigy Corporation) as a photopolymerization initiator were dissolved in 20 parts by mass of methylene chloride. The solution thus obtained was then irradiated with light as it was so that was polymerized to obtain a mass-average molecular mass of 3,500. This solution was then dissolved in 560 parts by mass of the cellulose acylate solution 1 of Example 1. The dope solution thus obtained was filtered, and then casted using a band flow casting machine. The mass ratio of the cycloolefin compound A to cellulose acylate was 50%. When the amount of residual solvent in the film reached 30%, the film was peeled off the band, dried at 100° C. for 10 minutes and then at 140° C. for 20 minutes, passed through an ultraviolet irradiation zone where it was then irradiated with ultraviolet rays at a dose of 500 mJ/cm², and then wound to obtain a hybrid film 004. The hybrid film thus obtained had a solvent left therein in an amount of 0.1% or less and a thickness of 80 μm.

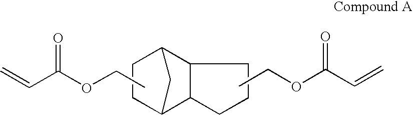

### Example 5

A hybrid film 005 having a thickness of 80 μm was prepared in the same manner as in Example 4 except that the cycloolefin compound A was replaced by 50 parts by mass of the following cycloolefin compound B and irradiation with light was effected to obtain a mass-average molecular mass of 3,000.

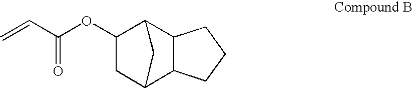

### Example 6

A hybrid film 006 having a thickness of 80 μm was prepared in the same manner as in Example 4 except that the compound A was not irradiated with light in the form of solution but was used in the form of monomer.

### Example 7

100 parts by mass of a cellulose acetate having an acetyl substitution degree of 2.06, a propionyl substitution degree of 0.79 and a total substitution degree of 2.85, 400 parts by mass of methylene chloride and 60 parts by mass of methanol were charged in a mixing tank where they were then stirred and dissolved to prepare a cellulose acylate solution 3. A hybrid film 007 having a thickness of 801m was prepared in the same manner as in Example 3 except that the cellulose acylate solution 3 was used instead of the cellulose acylate solution 1.

### Example 8

100 parts by mass of a cellulose acetate having an acetyl substitution degree of 1.00, a butyryl substitution degree of 1.70 and a total substitution degree of 2.70, 400 parts by mass of methylene chloride and 60 parts by mass of methanol were charged in a mixing tank where they were then stirred and dissolved to prepare a cellulose acylate solution 4. A hybrid film 008 having a thickness of 80 μm was prepared in the same manner as in Example 4 except that the cellulose acylate solution 4 was used instead of the cellulose acylate solution 1.

### Example 9

100 parts by mass of a cellulose acetate having an acetyl substitution degree of 1.00, a butyryl substitution degree of 1.70 and a total substitution degree of 2.70, 20 parts by mass of a pelletized material obtained by drying the solution 2 containing a cycloolefin compound as used in Example 1 and then finely grinding the resin thus obtained and 10 parts by mass of a plasticizer TPP (triphenyl phosphate) were press-molded with a spacer interposed therebetween at a temperature of 250° C. and 5 MPa in a heat press so that a thickness of 80 μm was reached. The resin thus press-molded was then heat-melted to obtain a hybrid film 009.

### Comparative Example 1

It was attempted to dissolve the ZEONOR solution which had not been subjected to ultrasonic treatment as in Example 1 (molecular mass: greater than 20,000 but difficultly confirmed) in the cellulose acylate solution 1 prepared in Example 1. However, the ZEONOR solution was not fully dissolved in the cellulose acylate solution 1. A comparative film 100 was prepared from this solution in the same manner as in Example 1. However, the film thus obtained showed an insufficient transparency and thus could be difficultly used as an optical film.

### Comparative Example 2

The cellulose acylate solution 1 prepared in Example 1 was singly subjected to casting to obtain a comparative film 101 having a thickness of 80 μm.

### Comparative Example 3

The cellulose acylate solution 1 prepared in Example 1 was singly subjected to filtration and flow casting using a band flow casting machine in the same manner as in Example 4. When the amount of residual solvent in the film reached 30%, the film was peeled off the band, dried at 100° C. for 10 minutes and then at 140° C. for 20 minutes, and then wound to obtain a hybrid film 102 having a thickness of 80 μm.

### Comparative Example 4

The cellulose acylate solution 3 prepared in Example 7 was singly processed in the same manner as in Example 7 to obtain a hybrid film 103 having a thickness of 80 μm.

### Comparative Example 5

The cellulose acylate solution 4 prepared in Example 8 was singly processed in the same manner as in Example 8 to obtain a hybrid film 104 having a thickness of 80 μm.

### Comparative Example 6

100 parts by mass of a cellulose acetate having an acetyl substitution degree of 1.00, a butyryl substitution degree of 1.70 and a total substitution degree of 2.70 as used in Example 9 and 10 parts by mass of a plasticizer TPP (triphenyl phosphate) were press-molded with a spacer interposed therebetween at a temperature of 250° C. and 5 MPa in a heat press so that a thickness of 80 μm was reached. The resin thus press-molded was then heat-melted to obtain a comparative film 105.

### Comparative Example 7

ZEONOR (ZF-14, produced by ZEON CORPORATION), which is a thermoplastic norbornene-based resin, was prepared as a comparative film 106.

### Comparative Example 8

ARTON (produced by JSR Corporation), which is a thermoplastic norbornene-based resin, was prepared as a comparative film 107.

### Comparative Example 9

In order to compare with the hybrid film containing a cycloolefin compound of the invention, a comparative sample containing a polyester was prepared. In some detail, according to the method of preparing Sample No. 6 of Example 1 of JP-A-2002-22956, 100 parts by mass of a cellulose acylate having an acetyl substitution degree of 2.88 and 15 parts by mass of a polyester having a molecular mass of 5,500 were used to prepare a dope which was then subjected to flow casting in the same manner as in Example 4 to obtain a comparative film 108 having a thickness of 80 μm. The film thus obtained had an insufficient transparency and thus could be difficultly used as an optical film.

The formulation, film forming method and physical properties of the hybrid films 001 to 009 obtained in Examples 1 to 9 and the comparative films 100 to 108 obtained in Comparative Examples 1 to 9 are set forth in Table 1.

TABLE 1

| | | | Cycloolefin | | | | |
|---|---|---|---|---|---|---|---|
| | | | compound | | | | |
| | | Substitution | Preparation | | Film forming | | Thickness |
| | No. | degree | conditions | MW | method | | μm |
| Example | 001 | Ac2.86 | ZEONOR + | 12,000 | Solution | Casting | 80 |
| | | | ultrasonic | | film | | |
| | | | 20 min | | forming | | |
| | 002 | Ac2.86 | ZEONOR + | 4,500 | | Casting | 80 |
| | | | ultrasonic | | | | |
| | | | 40 min | | | | |
| | 003 | Ac2.86 | ARTON + | 8,000 | | Casting | 80 |
| | | | ultrasonic | | | | |
| | | | 20 min | | | | |
| | 004 | Ac2.86 | Compound A | 3,500 | | Flow | 80 |
| | | | (polymerization) | | | casting | |
| | 005 | Ac2.86 | Compound B | 3,000 | | Flow | 80 |
| | | | (polymerization) | | | casting | |
| | 006 | Ac2.86 | Compound A | 302 | | Flow | 80 |
| | | | | | | casting | |
| | 007 | Ac2.06 + | Compound A | 3,500 | | Flow | 80 |
| | | Pro0.79 | (polymerization) | | | casting | |
| | 008 | Ac1.0 + | Compound A | 3,500 | | Flow | 80 |
| | | Bu1.7 | (polymerization) | | | casting | |
| | 009 | Ac1.0 + | ZEONOR + | 12,000 | Melt | Heat | 80 |
| | | Bu1.7 | ultrasonic | | film | press | |
| | | | 20 min | | forming | | |
| Comparative | 100 | Ac2.86 | ZEONOR | More | Solution | — | 80 |
| Example | | | (untreated) | than | film | | |
| | | | | 20,000 | forming | | |
| | 101 | Ac2.86 | — | — | | Casting | 80 |
| | 102 | Ac2.86 | — | — | | Flow | 80 |
| | | | | | | casting | |
| | 103 | Ac2.06 + | — | — | | Flow | 80 |
| | | Pro0.79 | | | | casting | |
| | 104 | Ac1.0 + | — | — | | Flow | 80 |
| | | Bu1.7 | | | | casting | |
| | 105 | Ac1.0 + | — | — | Melt | Heat | 80 |
| | | Bu1.7 | | | film | press | |
| | 106 | — | ZEONOR | More | forming | — | 100 |
| | | | | than | | | |
| | | | | 20,000 | | | |
| | 107 | — | ARTON | More | | * | 100 |
| | | | | than | | | |
| | | | | 20,000 | | | |
| | 108 | Ac2.88 | Polyester | 5,500 | Soultion | Flow | 80 |
| | | | | | film | casting | |
| | | | | | forming | | |

| | | | | | Tensile | Photo- | |
|---|---|---|---|---|---|---|---|
| | | | Moisture | Elastic | elongation | elastic | % |
| | | | permeability | modulus | at | coefficient * | Dimensional |
| | No. | Haze % | g/m² · 24 hr | GPa | break % | 10⁻¹³ N/m² | change |
| Example | 001 | 1.62 | 460 | 3.19 | 10 | 0.92 (0.79) | −0.08 |
| | | | (0.19) | (0.86) | (0.59) | | (0.67) |
| | 002 | 0.76 | 420 | 3.27 | 10 | 0.91 (0.78) | −0.08 |
| | | | (0.17) | (0.88) | (0.59) | | (0.67) |
| | 003 | 1.21 | 620 | 2.90 | 12 | 0.93 (0.79) | −0.09 |
| | | | (0.26) | (0.78) | (0.71) | | (0.75) |
| | 004 | 0.45 | 1150 | 4.23 | 12 | 0.85 (0.72) | −0.08 |
| | | | (0.47) | (1.12) | (0.71) | | (0.57) |
| | 005 | 0.48 | 1250 | 4.07 | 13 | 0.87 (0.74) | −0.07 |
| | | | (0.51) | (1.08) | (0.76) | | (0.50) |
| | 006 | 0.37 | 1800 | 3.98 | 9 | 1.05 (0.89) | −0.10 |
| | | | (0.73) | (1.05) | (0.53) | | (0.71 |
| | 007 | 0.49 | 1280 | 4.04 | 16 | 0.91 (0.75) | −0.09 |
| | | | (0.52) | (1.12) | (0.89) | | (0.60) |
| | 008 | 0.52 | 1350 | 3.95 | 15 | 0.93 (0.75) | −0.08 |
| | | | (0.54) | (1.09) | (0.83) | | (0.47) |
| | 009 | 1.75 | 890 | 3.55 | 8 | 0.95 (0.76) | −0.15 |
| | | | (0.33) | (1.06) | (0.67) | | (0.68) |
| Comparative | 100 | 3.5 | — | — | — | — | — |
| Example | | or | | | | | |
| | | more | | | | | |
| | 101 | 0.32 | 2410 | 3.72 | 17 | 1.17 | −0.12 |
| | 102 | 0.34 | 2450 | 3.78 | 17 | 1.18 | −0.14 |
| | 103 | 0.35 | 2465 | 3.60 | 18 | 1.22 | −0.15 |
| | 104 | 0.39 | 2500 | 3.64 | 18 | 1.24 | −0.17 |
| | 105 | 0.86 | 2680 | 3.35 | 12 | 1.25 | −0.22 |
| | 106 | 0.48 | 10 | 2.40 | 5 | 0.3 | −0.04 |
| | 107 | 0.56 | 210 | 2.33 | 6 | 0.7 | −0.06 |
| | 108 | 2.82 | — | — | — | — | — |

Note)
The substitution degree indicates the degree of substitution by cellulose acylate. Ac represents the acetyl substitution degree, Pro represents the propionyl substitution degree, and Bu represents the butyryl substitution degree. The figure in the parenthesis indicates the ratio of physical properties of the hybrid film of the example to that of the film prepared from cellulose acylate alone.

As set forth in Table 1, as compared with the comparative sample 101 free of cycloolefin compound prepared in the same manner as in the hybrid film 001 of the invention, the hybrid film 001 of the invention showed a reduced moisture permeability, a raised elastic modulus, a reduced photoelastic coefficient, a reduced dimensional change and hence improved film properties. Similarly, the hybrid films 002 to 009, too, showed better properties than the respective corresponding comparative film. All the samples of the invention showed a small haze and a sufficient transparency. The comparative sample 100, which comprises a cycloolefin compound having too great a molecular mass and thus has the cycloolefin compound insufficiently dissolved therein, and the comparative sample 108, which comprises a polyester rather than a cycloolefin compound, showed an insufficient transparency and thus had no sufficient film properties.

### Example 10

### Preparation of Polarizing Plate

The inventive hybrid film 001 was dipped in a 1.5 N aqueous solution of sodium hydroxide at 55° C. for 2 minutes. The hybrid film was washed in a rinse bath at room temperature, and then neutralized with a 0.1 N sulfuric acid at 30° C. The hybrid film was again washed in a rise bath at room temperature, and then dried with 100° C. hot air. Thus, the hybrid film was saponified on the surface thereof. Subsequently, the rolled polyvinyl alcohol film having a thickness of 80 μm was continuously stretched by a factor of 5 in an aqueous solution of iodine, and then dried to obtain a polarizer having a thickness of 20 μm. With a 3% aqueous solution of a polyvinyl alcohol (PVA-117H, produced by KURARAY CO., LTD.) as an adhesive, two sheets of two sheets of the aforementioned saponified hybrid film 001 were stuck to each other with the aforementioned polarizer interposed therebetween to obtain a polarizing plate the both surfaces of which are protected by the hybrid film 001. The arrangement was made such that the slow axis of the hybrid film 001 on the both sides of the polarizer are disposed parallel to the transmission axis of the polarizer. Thus, a polarizing plate 001 was prepared. Similarly, the hybrid films 002 to 009 and the comparative films 101 to 107, too, were used to prepare polarizing plates. These polarizing plates will be hereinafter referred to as “polarizing plates 001 to 009 and 101 to 107”, respectively. All the polarizing plates 001 to 009 had a sufficient polarization.

### (Durability Test on Polarizing Plate)

The polarizing plate samples 001 to 009 and polarizing plate samples 101 to 107 thus prepared were each cut into a sample having a size of 20 cm×30 cm which was then fixed with an adhesive to a glass sheet which was then allowed to stand under high temperature and humidity conditions of 60° C.-90% RH for 500 hours. These polarizing plate samples thus processed were each then returned to ordinary temperature and humidity conditions. These polarizing plate samples were each combined with another sheet of the same polarizing plate sample in crossed Nicols. A backlight was disposed on the back side of the crossed Nicols. The front side of the crossed Nicols was viewing side. The observation site was the frame of the polarizing plate sample (site 1 cm apart from the edge of the sample). The angle of in-plane rotation of the crossing absorption axis of the two sheets of polarizing plate were defined to be 0° and 90°, respectively. The laminate was then visually observed for light leakage in the direction inclined obliquely at a polar angle of 45° from the line perpendicular to the plane in the direction of rotation angle of 45°, which is in between 0° and 90°. The evaluation was made according to the following criterion.

No definite light leakage observed: G (good)

Some but practically tolerable light leakage observed: F (fair)

Definite light leakage observed: P (poor)

### (Evaluation of Adhesion of Polarizer)

In the polarizing plate sample prepared above, the sticking of the saponified surface of the inventive hybrid film or the comparative film to the polarizer is required to be made with a sufficient adhesion.

The polarizing plate comprising the inventive hybrid film was cut on one side thereof to a depth corresponding to the thickness of the hybrid film, which is a protective film, to form a square notch having a size of 5 mm×5 mm to which a commercially available cellophane tape having a width of 20 mm and a length of 30 mm was then stuck. The cellophane tape was then peeled off the notched area. This work was repeated. When the cellophane tape alone was peeled off, it was then judged that the protective film and the polarizer had been firmly bonded to each other. On the contrary, when the cellophane tape was peeled off together with the protective film, it was then judged that the adhesion between the protective film and the polarizer had been insufficient. This work was conducted 50 times. The adhesion was then evaluated according to the following three-step criterion.

Protective film not peeled even after 50 repetitions: G (good)

Protective film peeled by 30 repetitions to less than 50 repetitions: F (fair)

Protective film peeled by less than 30 repetitions: P (poor)

### Example 11

### Preparation of Optically Compensatory Film

The hybrid film sample of the invention was used to prepare an optically compensatory film sample according to the method described in Example 1 of JP-A-2003-315541. A 25 wt-% solution prepared by dissolving a polyimide having a mass-average molecular mass (Mw) of 70,000 and Δn of about 0.04 synthesized from 2,2′-bis(3,4-dicarboxyphenyl)hexafluoropropane dianhydride (6FDA) and 2,2′-bis(trifluoromethyl)-4,4′-diaminobiphenyl (TFMB) in cyclohexanone as a solvent was spread over the inventive hybrid film sample 004 (thickness: 80 μm) prepared in Example 4. Thereafter, the coated material was subjected to heat treatment at 100° C. for 10 minutes, and then subjected to 15% longitudinal monoaxial stretching at 160° C. to obtain an optically compensatory film having a polyimide film having a thickness of 6 μm spread over the inventive hybrid film. The optically compensatory film thus prepared had Re of 75 nm, Rth of 220 nm and an alignment axis deviation angle of ±0.3°. The optically compensatory film had a birefringent layer that satisfies nx>ny>nz.

### Comparative Example

An optically compensatory film having a polyimide film having a thickness of 6 μm spread over the comparative film sample 102 was prepared in the same manner as mentioned above except that the solution was spread over the comparative sample 102 (thickness: 80 μm) instead of the aforementioned hybrid film sample 004. The optically compensatory film had Re of 75 nm and Rth of 220 nm.

### (Evaluation of Mounting on VA Mode Liquid Crystal Display Device)

The optically compensatory film obtained in Example 11 was subjected to alkaline saponification on the side thereof free of polyimide film. The optically compensatory film was then bonded directly to a polarizer on the saponified side thereof with a polyvinyl alcohol-based adhesive. The arrangement was made such that the nx direction of the optically compensatory film and the absorption axis of the polarizing plate are perpendicular to each other. The optically compensatory film was stuck to a VA mode liquid crystal display device panel with an adhesive in such an arrangement that it is on the liquid crystal cell side thereof. On the opposite side of the liquid crystal cell, the polarizing plate alone was stuck to the VA liquid crystal panel with an adhesive in such an arrangement that the absorption axis of the polarizing plates are perpendicular to each other to obtain a liquid crystal display device 004. The optically compensatory film obtained in the aforementioned comparative example, too, was stuck to the VA mode liquid crystal panel in the same manner as mentioned above to obtain a liquid crystal display device 102.

### (Evaluation of Corner Unevenness of VA Mode Liquid Crystal Display Device)

The liquid crystal display devices 004 and 102 thus obtained were turned ON at the same time, and then kept displaying in black for 24 hours. These liquid crystal display devices were each then observed at a site 1 cm apart from the four corners thereof. The corner unevenness was then evaluated according to the following criterion.

No definite uneven light leakage observed: G (good)

Some but practically tolerable light leakage observed: F (fair)

Definite light leakage observed: P (poor)

The results of evaluation of Examples 10 and 11 are set forth in Table 2 below.

TABLE 2

| | | | Cycloolefin | | | | | Durability | | |
|---|---|---|---|---|---|---|---|---|---|---|
| | | | compound | | | | | test on | Adhesion | VA panel |
| | | Substitution | Preparation | | Film forming | | Thickness | polarizing | to | corner |
| | No. | degree | conditions | MW | method | | μm | plate | polarizer | unevenness |
| Example | 001 | Ac2.86 | ZEONOR + | 12,000 | Solution | Casting | 80 | G | G | — |
| | | | ultrasonic 20 min | | film | | | | | |
| | 002 | Ac2.86 | ZEONOR + | 4,500 | forming | Casting | 80 | G | G | — |
| | | | ultrasonic 40 min | | | | | | | |
| | 003 | Ac2.86 | ARTON + | 8,000 | | Casting | 80 | G | G | — |
| | | | ultrasonic 20 min | | | | | | | |
| | 004 | Ac2.86 | Compound A | 3,500 | | Flow | 80 | G | G | G |
| | | | (polymerization) | | | casting | | | | |
| | 005 | Ac2.86 | Compound B | 3,000 | | Flow | 80 | G | G | — |
| | | | (polymerization) | | | casting | | | | |
| | 006 | Ac2.86 | Compound A | 302 | | Flow | 80 | G | G | — |
| | | | | | | casting | | | | |
| | 007 | Ac2.06 + | Compound A | 3,500 | | Flow | 80 | G | G | — |
| | | Pro0.79 | (polymerization) | | | casting | | | | |
| | 008 | Ac1.0 + | Compound A | 3,500 | | Flow | 80 | G | G | — |
| | | Bu1.7 | (polymerization) | | | casting | | | | |
| | 009 | Ac1.0 + | ZEONOR + | 12,000 | Melt | Heat | 80 | G | F | — |
| | | Bu1.7 | ultrasonic 20 min | | film | press | | | | |
| | | | | | forming | | | | | |
| Comparative | 100 | Ac2.86 | ZEONOR | More | Solution | — | 80 | — | — | — |
| Example | | | (untreated) | than | film | | | | | |
| | | | | 20,000 | forming | | | | | |
| | 101 | Ac2.86 | — | — | | Casting | 80 | F | G | — |
| | 102 | Ac2.86 | — | — | | Flow | 80 | F | G | F |
| | | | | | | casting | | | | |
| | 103 | Ac2.06 + | — | — | | Flow | 80 | F | G | — |
| | | Pro0.79 | | | | casting | | | | |
| | 104 | Ac1.0 + | — | — | | Flow | 80 | F | G | — |
| | | Bu1.7 | | | | casting | | | | |
| | 105 | Ac1.0 + | — | — | Melt | Heat | 80 | F | G | — |
| | | Bu1.7 | | | film | press | | | | |
| | 106 | — | ZEONOR | More | forming | — | 100 | F | P | — |
| | | | | than | | | | | (peeled) | |
| | | | | 20,000 | | | | | | |
| | 107 | — | ARTON | More | | — | 100 | F | P | — |
| | | | | than | | | | | (peeled) | |
| | | | | 20,000 | | | | | | |
| | 108 | Ac2.88 | Polyester | 5,500 | Solution | Flow | 80 | — | — | — |
| | | | | | film | casting | | | | |
| | | | | | forming | | | | | |

Note)
The substitution degree indicates the degree of substitution by cellulose acylate. Ac represents the acetyl substitution degree, Pro represents the propionyl substitution degree, and Bu represents the butyryl substitution degree.

The polarizing plates 001 to 009 comprising the hybrid film of the invention showed less light leakage than the polarizing plates 101 to 107 and thus exhibited an excellent durability. Further, the inventive hybrid films 001 to 009 and the comparative samples 101 to 105 showed a good adhesion between the saponified surface of the film and the polarizer. On the other hand, the comparative samples 106 and 107, which are made of a resin singly composed of a cycloolefin compound, showed a high hydrophilicity and hence a poor adhesion and thus could not be stuck to the polarizer.

The liquid crystal display device 004 comprising the inventive hybrid film 004 showed no corner unevenness (light leakage) and hence a better durability than the liquid crystal display device 102 comprising the comparative sample 102.

As mentioned above, the hybrid film of the invention exhibits a better durability than the comparative sample film singly composed of a cellulose acylate free of cycloolefin compound and a better adhesion to polarizer than ZEONOR or ARTON, which is singly composed of cycloolefin compound. The hybridization of a cellulose acylate with a cycloolefin compound having a molecular mass falling within a specified range makes it possible to provide a hybrid film having characteristics of cellulose acylate film and characteristics of cycloolefin-based film in combination.

### INDUSTRIAL APPLICABILITY

In accordance with the invention, a hybrid film having characteristics of cellulose acylate film and characteristics of cycloolefin-based film in combination and a method for the production thereof can be provided. The hybrid film of the invention has an excellent transparency like cellulose acylate film, an excellent planarity developed by solution filming, a proper moisture permeability, a good adhesion to PVA which is a polarizer, an elastic modulus suitable for handling as film and showing little dimensional change and a small temperature and humidity dependence of optical anisotropy (retardation) and hence an excellent durability like cycloolefin-based film. Further, the use of this hybrid film as support for optically compensatory film or protective film for polarizing plate makes it possible to provide a liquid crystal display device which causes little frame defectives or corner unevenness. The liquid crystal display device of the invention is useful for VA mode and IPS mode, which has recently showed a trend for more use in TV, which has showed a trend for larger size.

The entire disclosure of each and every foreign patent application from which the benefit of foreign priority has been claimed in the present application is incorporated herein by reference, as if fully set forth.

1. A hybrid film comprising:
a cellulose acylate; and
a cycloolefin compound having a mass-average molecular mass of from 200 to 20,000.

2. The hybrid film according to claim 1,
wherein the cellulose acylate has an acyl substitution degree of from 2.0 to 3.0.

3. The hybrid film according to claim 2,
wherein the cellulose acylate has an acyl-substituted group that comprises substantially only an acetyl group, and has an acyl substitution degree of from 2.5 to 3.0.

4. The hybrid film according to claim 2,
wherein the cellulose acylate has an acyl-substituted group that comprises substantially at least two groups selected from the group consisting of acetyl group, propionyl group and butanoyl group.

5. The hybrid film according to claim 2,
wherein the cellulose acylate has an acyl-substituted group that comprises substantially acetyl group and propionyl group.

6. The hybrid film according to claim 1, which has a haze of from 0.01% to 5.0%.

7. The hybrid film according to claim 1, which has a thickness of from 20 μm to 200 μm.

8. The hybrid film according to claim 1, which satisfies relationship (1):
A/B≦0.98 (1)
wherein A represents a moisture permeability of the hybrid film; and
B represents a moisture permeability of a film prepared from only the cellulose acylate contained in the hybrid film.

9. The hybrid film according to claim 1, which satisfies relationship (2):
0.5≦C/D≦1.5 (2)
wherein C represents an elastic modulus of the hybrid film; and
D represents an elastic modulus of a film prepared from only the cellulose acylate contained in the hybrid film.

10. The hybrid film according to claim 1, which satisfies relationship (3):
0.5≦E/F≦1.5 (3)
wherein E represents a tensile elongation at break of the hybrid film; and
F represents an tensile elongation at break of a film prepared from only the cellulose acylate contained in the hybrid film.

11. The hybrid film according to claim 1, which satisfies relationship (4):
G/H≦0.98 (4)
wherein G represents a photoelastic coefficient of the hybrid film; and
H represents a photoelastic coefficient of a film prepared from only the cellulose acylate contained in the hybrid film.

12. The hybrid film according to claim 1, which satisfies relationship (5):
I/J≦0.98 (5)
wherein I represents a percent dimensional change (%) of the hybrid film; and
J represents a percent dimensional change (%) of a film prepared from only the cellulose acylate contained in the hybrid film.

13. A method for a production of a hybrid film according to claim 1, which comprises:
preparing a dope solution in which a cellulose acylate and a cycloolefin compound having a mass-average molecular mass of from 200 to 20,000 are dissolved in admixture; and
forming a film from the dope solution.

14. The method according to claim 13,
wherein the cycloolefin compound is prepared by lowering a molecular mass of a thermoplastic norbornene-based resin.

15. The method according to claim 13,
wherein the cycloolefin compound is prepared by polymerizing a cycloolefin monomer.

16. The method according to claim 13,
wherein the cycloolefin compound is a monomer having a molecular mass of from 200 to 3,000.

17. An optically compensatory film comprising:
a hybrid film according to claim 1; and
an optically anisotropic layer having a retardation Re of from 0 nm to 200 nm.

18. A polarizing plate comprising:
at least one of a hybrid film according to claim 1 and an optically compensatory film comprising: a hybrid film according to claim 1; and an optically anisotropic layer having a retardation Re of from 0 nm to 200 nm; and
a polarizer.

19. A liquid crystal display device comprising:
a liquid crystal cell; and
at least one of a hybrid film according to claim 1 and an optically compensatory film comprising: a hybrid film according to claim 1; and an optically anisotropic layer having a retardation Re of from 0 nm to 200 nm.

20. The optically compensatory film according to claim 17,
wherein the optically anisotropic layer comprises a layer that comprises a discotic liquid crystal compound.

21. The optically compensatory film according to claim 17,
wherein the optically anisotropic layer comprises a layer that comprises a rod-shaped liquid crystal compound.

22. The optically compensatory film according to claim 17,
wherein the optically anisotropic layer comprises a polymer film.

23. The optically compensatory film according to claim 22,
wherein the polymer film comprises at least one polymer material selected from the group consisting of polyamide, polyimide, polyester, polyether ketone, polyamide imide polyester imide and polyaryl ether ketone.

24. A polarizing plate comprising:
at least one of a hybrid film according to claim 1 and an optically compensatory film comprising: a hybrid film according to claim 1; and an optically anisotropic layer having a retardation Re of from 0 nm to 200 nm, wherein the optically anisotropic layer comprises a layer that comprises a discotic liquid crystal compound; and
a polarizer.

25. The polarizing plate according to claim 18, which has at least one layer selected from the group consisting of a hard coat layer, an anti-glare layer and an anti-reflection layer.

26. A liquid crystal display device comprising:
a liquid crystal cell; and
at least one of a hybrid film according to claim 1 and an optically compensatory film comprising: a hybrid film according to claim 1; and an optically anisotropic layer having a retardation Re of from 0 nm to 200 nm, wherein the optically anisotropic layer comprises a layer that comprises a discotic liquid crystal compound.

27. A liquid crystal display device according to claim 26, wherein the liquid crystal cell is of VA mode or IPS mode.
